(19) United States
(12) Patent Application Publication
(10) Pub. No.: US 2026/0185872 A1
(43) Pub. Date: Jul. 2, 2026

(54) SPECTROSCOPIC CAMERA

(71) Applicants: Public University Corporation Suwa University of Science Foundation, Nagano (JP); SEIKO EPSON CORPORATION, Tokyo (JP)

(72) Inventors: Shota YAMANAKA, MATSUMOTO SHI (JP); Masatoshi YONEKUBO, Nagano (JP)

(73) Assignees: Public University Corporation Suwa University of Science Foundation, Nagano (JP); SEIKO EPSON CORPORATION, Tokyo (JP)

(21) Appl. No.: 19/432,217

(22) Filed: Dec. 24, 2025

(30) Foreign Application Priority Data
Dec. 26, 2024 (JP) 2024-230417

(51) Int. Cl. G01J 3/26; G01J 3/02; G01J 3/28

(52) U.S. Cl. CPC G01J 3/26; G01J 3/0208; G01J 3/0229; G01J 3/2823; G01J 2003/2826

(57) ABSTRACT

A spectroscopic camera includes an etalon that transmits light of a wavelength corresponding to a gap dimension of a pair of reflective films; a detachable mount lens; an image sensor; and a relay optical system that relays an intermediate image formed by the mount lens to re-form an image at the image sensor and is adjusted to make light incident on the etalon at a desired angle. The relay optical system includes a first lens group that relays the intermediate image and emits collimated light to make it incident on the etalon, and a second lens group that forms an image of light emitted from the etalon at the image sensor. An image height of the intermediate image and a focal length of the first lens group satisfy E1≤0.27 in an evaluation formula E1 = (L1/f1).

### CROSS-REFERENCE TO RELATED APPLICATION

This application claims the priority benefits of Japanese application no. 2024-230417, filed on December 26, 2024. The entirety of the above-mentioned patent application is hereby incorporated by reference herein and made a part of this specification.

### BACKGROUND

### Technical Field

The disclosure relates to a spectroscopic camera.

### Related Art

Spectroscopic cameras use etalons (Fabry-Perot type tunable wavelength filter) (see Patent Document 1).

An etalon is capable of continuously changing the wavelength of transmitted light by continuously changing the spacing between opposing reflective surfaces.

### Citation List

### Patent Document

Patent Document 1: Japanese Patent Application Laid-Open Publication No. 2023-13471

### SUMMARY

### Technical Problem

In a spectroscopic camera using an etalon, if the light incident on the etalon is not made to be incident perpendicularly to the reflective surface of the etalon, the half width of the transmission wavelength may deteriorate, the position of the peak wavelength may shift, and desired spectral characteristics may not be obtained.

Among spectroscopic cameras using an etalon, lens-selectable spectroscopic cameras have the advantage of being able to use lenses with various focal lengths and specifications according to the application. However, the chief ray angles of a lens used differ respectively, the angular characteristics of light incident on the etalon change depending on the lens, and desired spectral characteristics may not be obtained.

On the other hand, there is a spectroscopic camera that limits the lens used to a specific standard lens and ensures that the incident angle to the etalon is within tolerance range such that desired spectral characteristics can be reliably obtained. However, in such a standard lens type spectroscopic camera, the lens cannot be changed according to the application.

The disclosure provides a spectroscopic camera that allows selection of a lens used according to the application and can obtain desired spectral characteristics.

### Solution to Problem

A spectroscopic camera according to one aspect of the present disclosure includes an etalon that transmits light of a wavelength corresponding to a gap dimension of a pair of reflective films; a detachable mount lens; an image sensor; and a relay optical system that relays an intermediate image formed by the mount lens to re-form an image at the image sensor and is adjusted to make light incident on the etalon at a desired angle. The relay optical system includes a first lens group that relays the intermediate image to emit a collimated light and make it incident on the etalon, and a second lens group that forms an image of light emitted from the etalon at the image sensor, and an image height L1 of the intermediate image and a focal length f1 of the first lens group satisfy E1≤0.27 in an evaluation formula E1 = (L1/f1).

A spectroscopic camera includes an etalon that transmits light of a wavelength corresponding to a gap dimension of a pair of reflective films; a detachable mount lens; an image sensor; and a relay optical system that relays an intermediate image formed by the mount lens to re-form an image at the image sensor and is adjusted to make light incident on the etalon at a desired angle. The relay optical system comprises a first lens group that relays the intermediate image to emit a collimated light and make it incident on the etalon, and a second lens group that forms an image of light emitted from the etalon at the image sensor, and a maximum value of an incident angle of the light from the first lens group to the etalon is 15 degrees.

### BRIEF DESCRIPTION OF THE DRAWINGS

FIG. 1 is a schematic diagram showing a configuration of a spectroscopic camera according to one embodiment of the present disclosure.

FIG. 2 is an optical path diagram of the spectroscopic camera according to the embodiment.

FIG. 3 is a diagram showing the relationship between an image height L1 of the intermediate image, a focal length f1 of the first lens group, and an incident angle θ to the etalon in the embodiment.

FIG. 4 is a graph showing the relationship between the incident angle θ and an evaluation formula E1 = (L1/f1) in the embodiment.

FIG. 5 is a graph showing the relationship between the incident angle θ and the spectral spectrum in the embodiment.

FIG. 6 is a graph showing the relationship between a focal length f2 of the second lens group and an evaluation formula E2 = (L2/L1) in the embodiment.

FIG. 7 is a graph showing the relationship between the F-number of the second lens group and the evaluation formula E2 = (L2/L1) in the embodiment.

### DESCRIPTION OF THE EMBODIMENTS

Hereinafter, one embodiment of the disclosure will be described.

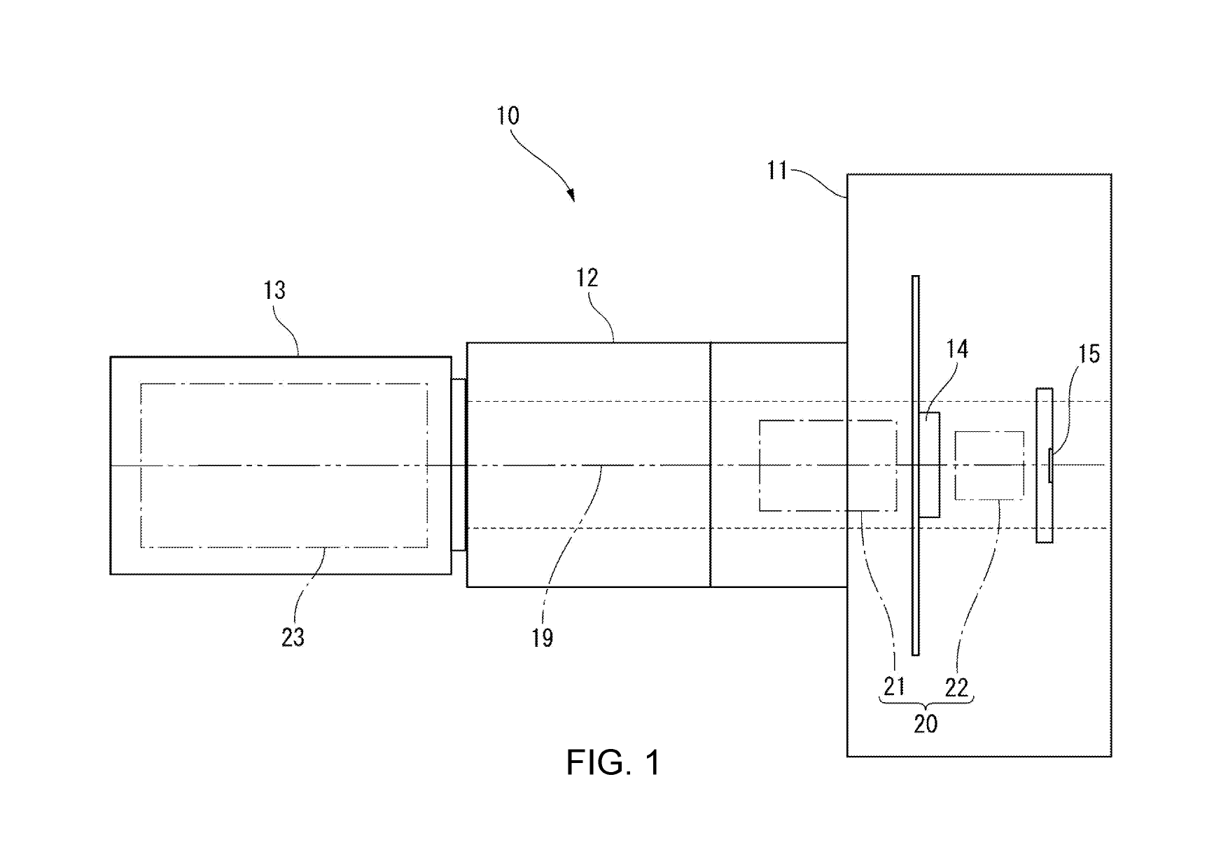

In FIG. 1, a spectroscopic camera 10 includes a housing 11; a lens barrel 12 coupled to the housing 11; and a mount lens 13 attached to the lens barrel 12. The mount lens 13 is detachable from the lens barrel 12 and is replaceable with one selected from multiple mount lenses having different characteristics according to the application.

Inside the housing 11, an etalon 14 that transmits light of a wavelength corresponding to the gap dimension of a pair of reflective films and an image sensor 15 that detects an incident light beam as an image are installed. The etalon 14, the image sensor 15, and the mount lens 13 are arranged along a respective reference optical axis 19.

A first lens group 21 is installed on the side of the etalon 14 where the lens barrel 12 is located. A second lens group 22 is installed between the etalon 14 and the image sensor 15. A mount lens group 23 is installed inside the mount lens 13.

The first lens group 21 and the second lens group 22 constitute a relay optical system 20 that relays an intermediate image formed by the mount lens group 23 and re-forms an image at the image sensor 15. The relay optical system 20 is adjusted to make light incident on the etalon 14 at a desired angle.

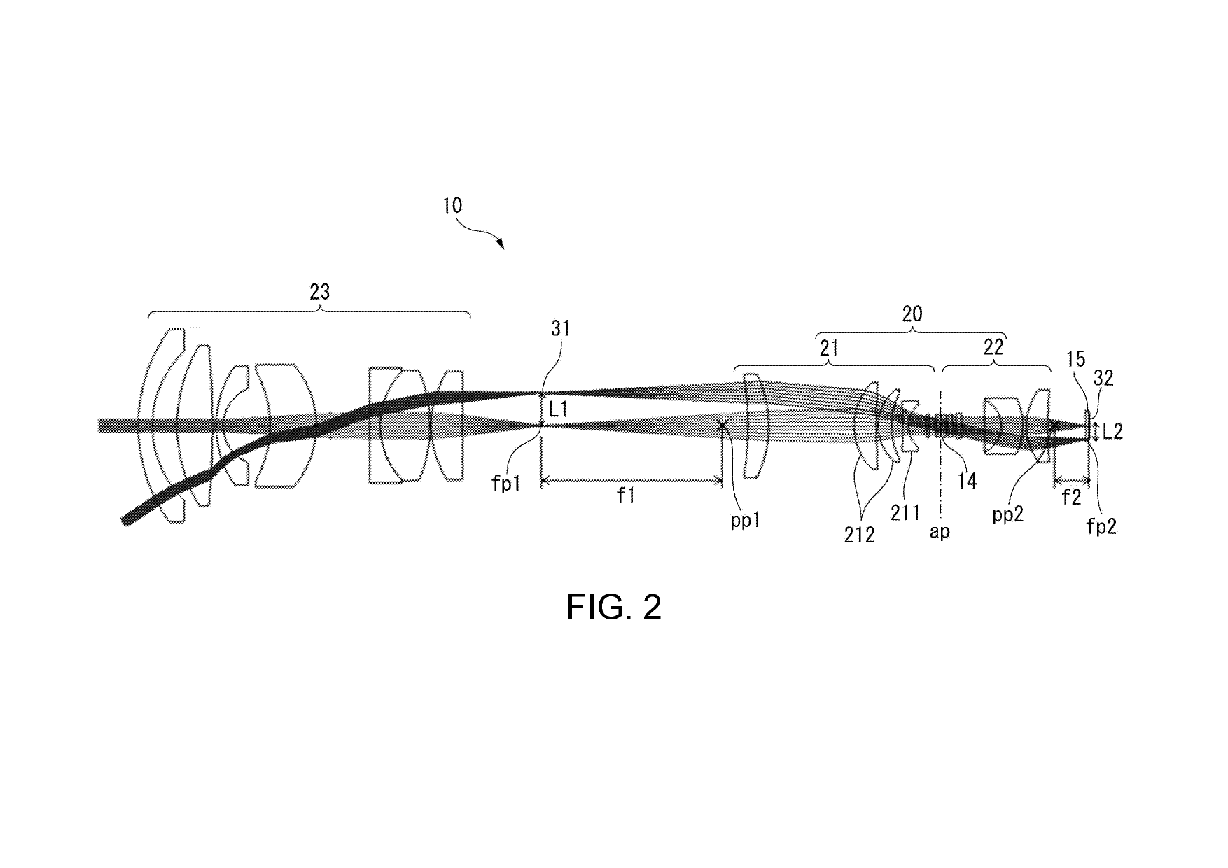

In FIG. 2, a light beam from a light source (not shown) forms an intermediate image 31 by the mount lens group 23.

The first lens group 21 relays the intermediate image 31 to emit a collimated light and makes it incident on the etalon 14. In order to emit the collimated light to the etalon 14, the first lens group 21 has at least one concave lens 211, and multiple convex lenses 212 are disposed on the incident side of the concave lens 211. The first lens group 21 has a focal length f1 that is the distance from an object side principal point pp1 to an object side focal point fp1.

The etalon 14 transmits light of a specified wavelength and emits it to the second lens group 22. The etalon 14 is disposed at a position ap of an aperture of the relay optical system 20.

The second lens group 22 forms the light emitted from the etalon 14 at the image sensor 15 and generates an image 32. The second lens group 22 has a focal length f2 that is the distance from an image side principal point pp2 to an image side focal point fp2.

In the relay optical system 20, an image height L1 of the intermediate image 31 and the focal length f1 of the first lens group 21 are set to satisfy E1≤0.27 in an evaluation formula E1 = (L1/f1).

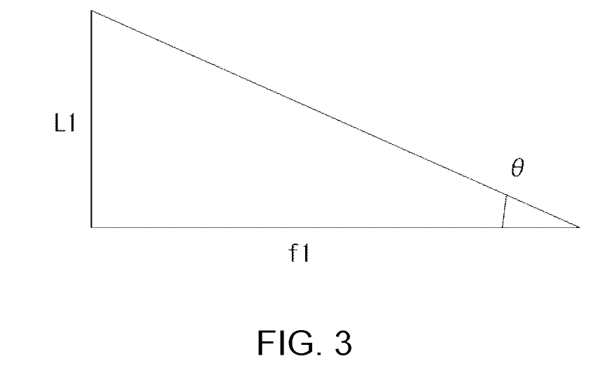

As shown in FIG. 3, the image height L1 of the intermediate image 31 satisfies θ = arctan(L1/f1) with respect to the focal length f1 of the first lens group 21, where θ is a maximum incident angle to the etalon 14. Here, in a case where the evaluation formula is E1 = (L1/f1), in order to suppress the maximum incident angle θ to the etalon 14, the evaluation formula E1 should be made small, that is, the image height L1 should be made small or the focal length f1 should be made long.

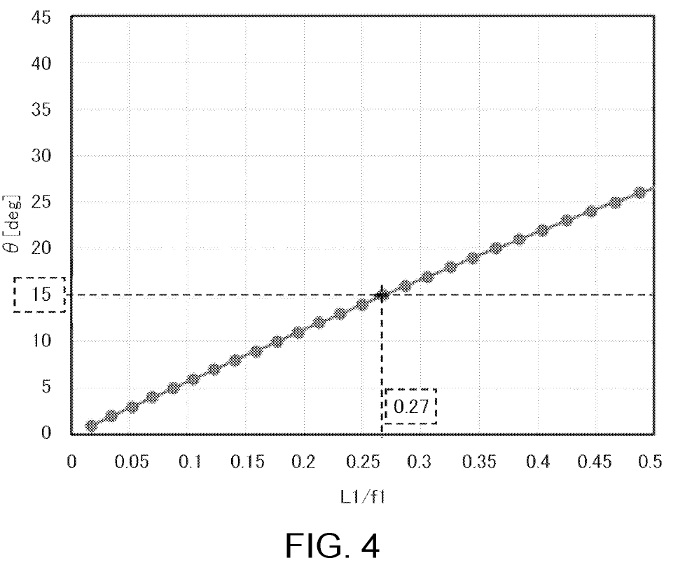

FIG. 4 shows the relationship between the incident angle θ to the etalon 14 and the evaluation formula E1 = (L1/f1). In the same figure, as the evaluation formula E1 = (L1/f1) becomes larger, the incident angle θ also becomes larger.

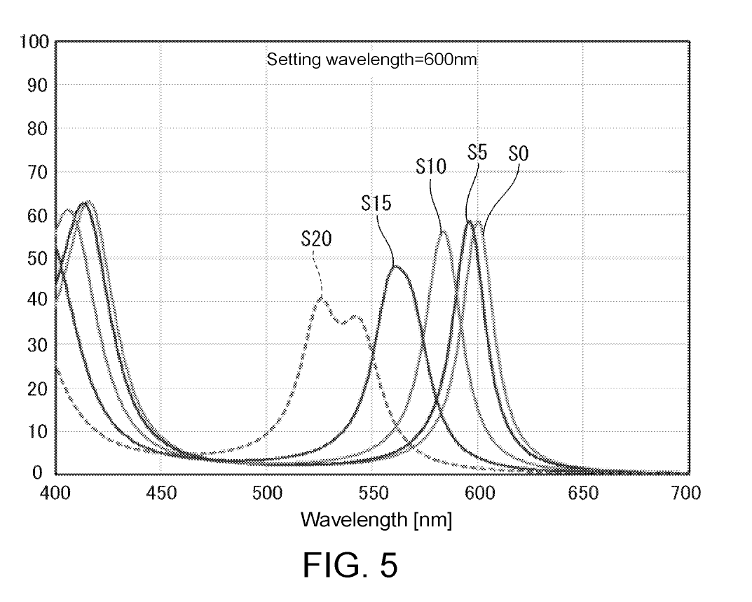

FIG. 5 shows the relationship between the incident angle θ to the etalon 14 and the spectral spectrum. In the same figure, curves S0 to S20 are spectral spectra at a setting wavelength of 600nm for incident angles θ of 0 degrees, 5 degrees, 10 degrees, 15 degrees, and 20 degrees, respectively.

In FIG. 5, the curves S0 to S20 show that as the incident angle θ becomes larger, the spectral spectrum shifts toward the short wavelength side with respect to the setting wavelength. While the curves S0 to S15 with incident angles θ up to 20 degrees maintain a single peak, the curve S20 with an incident angle θ of 20 degrees shows a double peak. Since it is difficult to correct such double peak, it is necessary to carry out optical design such that light with an incident angle θ of 20 degrees or more is not incident on the etalon 14. Therefore, in the relay optical system 20, the range up to an incident angle θ of 20 degrees where no double peak occurs (curves S0 to S15) is used, and the maximum value of the incident angle θ to the etalon 14 is set to 15 degrees.

In FIG. 4, in the case where the incident angle θ to the etalon 14 is 15 degrees, the evaluation formula E1 = (L1/f1) is 0.27.

Based on the above findings, the relay optical system 20 is set to satisfy the evaluation formula E1 = (L1/f1)≤0.27.

In the relay optical system 20, the image height L1 of the intermediate image 31 and the image height L2 of the image 32 formed at the image sensor 15 by the second lens group 22 are set to satisfy 0.2≤E2≤1.35 in an evaluation formula E2 = (L2/L1).

The etalon 14 generally stabilizes the spectral wavelength by suppressing tilting and deflection of the reflective film, so the reflective film is designed to be relatively small, and the image circle tends to be smaller compared to full sensor size (L1>L2). In the second lens group 22, since there is a relationship of L1:f1 = L2:f2 between the image height L2 and the focal length f2, in response to the magnification L2/L1 becoming smaller, the focal length f2 becomes shorter.

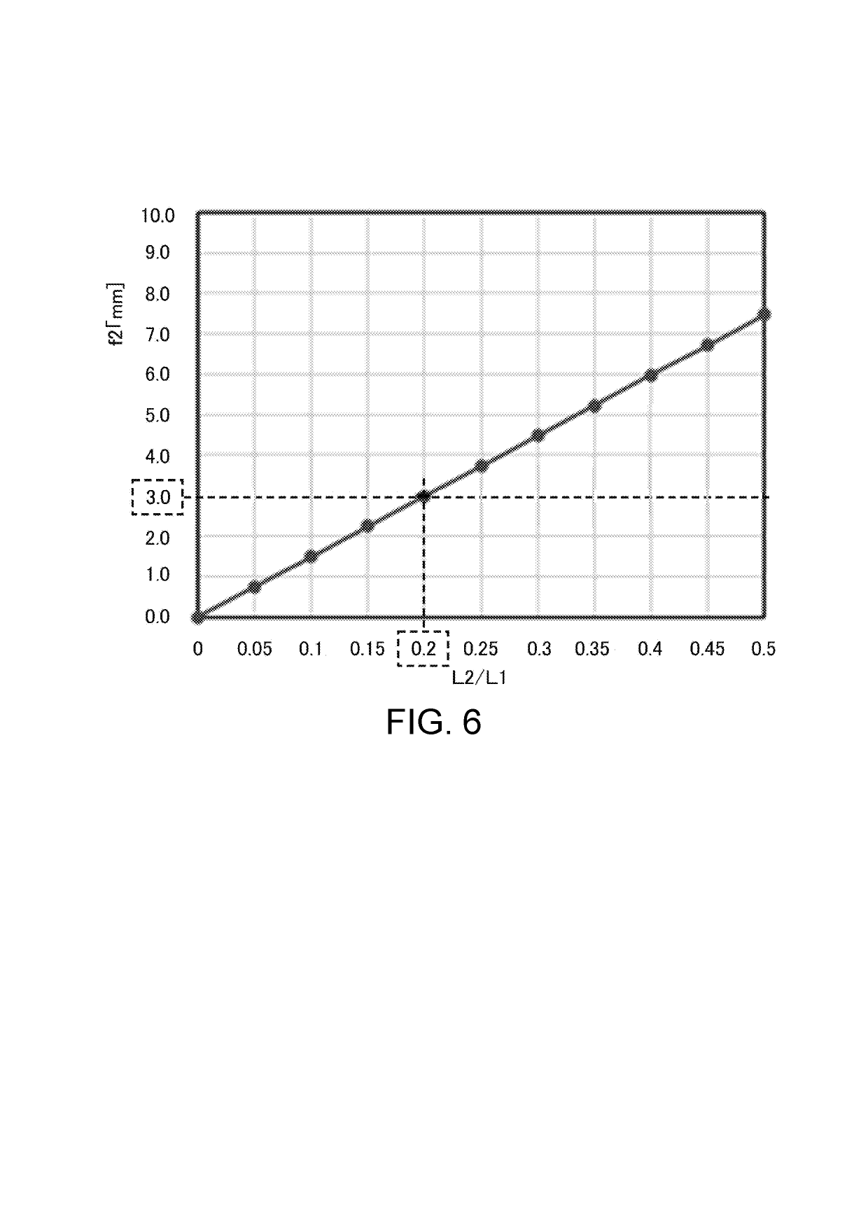

In FIG. 6, in the case where the magnification L2/L1 becomes smaller and the focal length f2 becomes 3mm or less, it is necessary to increase the power of the second lens group 22, leading to cost increase such as an increase in the number of lenses. Therefore, in the relay optical system 20, the magnification L2/L1, that is, the evaluation formula E2 is preferably ≥0.2.

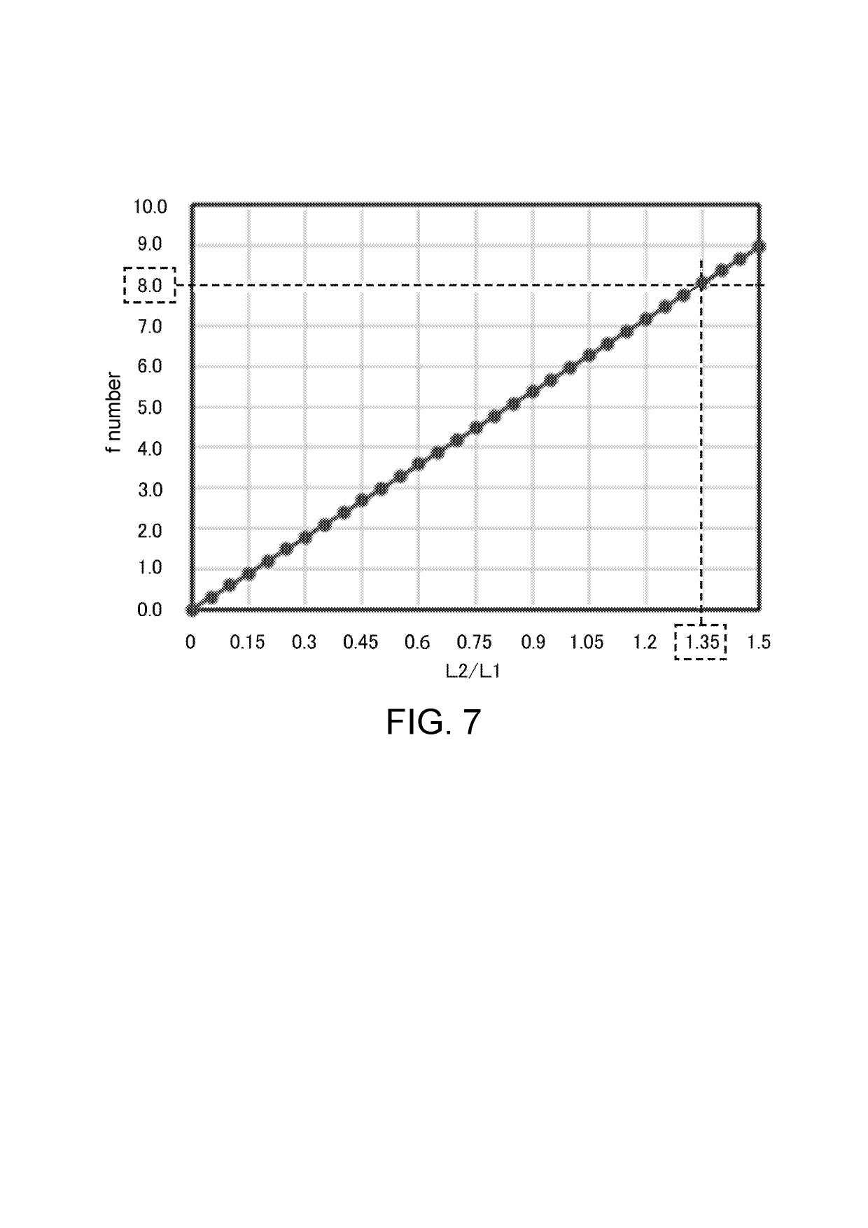

In FIG. 7, in the case of increasing the magnification L2/L1, the F-number of the optical system of the second lens group 22 becomes larger, and the amount of light reaching the image sensor 15 becomes smaller. In particular, in the case where the F-number exceeds 8.0, the shooting time of the spectroscopic camera 10 becomes longer, which is problematic in practical use. Therefore, in the relay optical system 20, the magnification L2/L1, that is, the evaluation formula E2 is preferably≤1.35.

Based on the above findings, the relay optical system 20 is set such that the evaluation formula E2 = (L2/L1) satisfies 0.2≤E2≤1.35.

### Operational Effect of the Present Embodiment

The spectroscopic camera 10 of the embodiment includes an etalon 14 that transmits light of wavelengths corresponding to the gap dimension of a pair of reflective films; a detachable mount lens 13; an image sensor 15; and a relay optical system 20 that relays the intermediate image 31 formed by the mount lens 13 to re-form an image 32 at the image sensor 15 and is adjusted to make light incident on the etalon 14 at a desired angle. Furthermore, the relay optical system 20 includes a first lens group 21 that relays the intermediate image 31 to emit the collimated light and make it incident on the etalon 14, and a second lens group 22 that forms an image of light emitted from the etalon 14 at the image sensor 15, and the image height L1 of the intermediate image 31 and the focal length f1 of the first lens group satisfy E1≤0.27 in the evaluation formula E1 = (L1/f1). That is, the maximum value of the incident angle of light from the first lens group 21 to the etalon 14 is 15 degrees.

According to such a configuration, by forming the intermediate image 31 with the mount lens 13 and then relaying this intermediate image 31 with the relay optical system 20 to re-form an image at the image sensor 15, any lens may be selected and configured as the mount lens 13. In the relay optical system 20, by setting the incident angle to the etalon 14 such that the image height L1 of the intermediate image 31 and the focal length f1 of the first lens group satisfy E1≤0.27 in the evaluation formula E1 = (L1/f1), the incident angle of the intermediate image 31 to the etalon 14 may be set to an appropriate angle (15 degrees or less) that can avoid double peaks in the spectral spectrum that are difficult to correct, and desired spectral characteristics can be obtained.

In the relay optical system 20 of the spectroscopic camera 10 of the embodiment, the image height L1 of the intermediate image 31 and the image height L2 of the image 32 formed at the image sensor 15 by the second lens group 22 satisfies 0.2≤E2≤1.35 in the evaluation formula E2 = (L2/L1).

According to such a configuration, by setting the evaluation formula E2≧0.2, the power of the second lens group 22 can be secured, and cost increase such as an increase in the number of lenses can be avoided. Also, by setting the evaluation formula E2≤1.35, the amount of light reaching the image sensor 15 can be secured, and an increase in shooting time of the spectroscopic camera 10 can be avoided.

In the spectroscopic camera 10 of the embodiment, the first lens group 21 has at least one concave lens 211 that emits the collimated light to the etalon 14, and multiple convex lenses 212 are disposed on the incident side of the concave lens 211.

According to such a configuration, by passing light from the convex lenses 212 on the incident side through at least one concave lens 211, appropriate collimated light may be emitted to the etalon 14.

In the spectroscopic camera 10 of the embodiment, the etalon 14 is disposed at the position ap of the aperture of the relay optical system 20.

According to such a configuration, by disposing the etalon 14 at the position ap of the aperture of the relay optical system 20, the diameter of the light beam incident on the etalon 14 may be minimized, and deviation in spectral characteristics between the central part and the peripheral part can be suppressed to obtain appropriate spectral performance.

### Modification Example

The disclosure is not limited to the aforementioned embodiments, and modifications within a range that can achieve the objectives of the disclosure are included in the disclosure.

In the aforementioned embodiment, the lens configurations of the first lens group 21 and the second lens group 22 of the relay optical system 20 may be appropriately set.

In the first lens group 21, the configuration is not limited to multiple convex lenses 212 being disposed on the incident side of the concave lens 211 as in the aforementioned embodiment, and there may be one convex lens 212 or three or more convex lenses 212. The concave lens 211 is also not limited to one and may be multiple. However, it is preferable that the concave lens 211 is disposed on the side of the first lens group 21 facing the etalon 14.

### Summary of the disclosure

A spectroscopic camera according to one aspect of the disclosure includes an etalon that transmits light of a wavelength corresponding to a gap dimension of a pair of reflective films; a detachable mount lens; an image sensor; and a relay optical system that relays an intermediate image formed by the mount lens to re-form an image at the image sensor and is adjusted to make light incident on the etalon at a desired angle,

the relay optical system includes a first lens group that relays the intermediate image to emit a collimated light and make it incident on the etalon, and a second lens group that forms an image of light emitted from the etalon at the image sensor, and

an image height L1 of the intermediate image and a focal length f1 of the first lens group satisfy E1≤0.27 in an evaluation formula E1 = (L1/f1).

According to such a configuration, by forming an intermediate image with the mount lens and then relaying this intermediate image with the relay optical system to re-form an image at the image sensor, any lens may be selected and configured as the mount lens. In the relay optical system, by setting the incident angle to the etalon such that the image height L1 of the intermediate image and the focal length f1 of the first lens group satisfy E1≤0.27 in the evaluation formula E1 = (L1/f1), the incident angle of the intermediate image to the etalon may be set to an appropriate angle that can avoid double peaks in the spectral spectrum that are difficult to correct, and desired spectral characteristics can be obtained.

In the relay optical system of the spectroscopic camera according to the aspect, the image height L1 of the intermediate image and the image height L2 of an image 32 formed at the image sensor by the second lens group satisfies 0.2≤E2≤1.35 in the evaluation formula E2 = (L2/L1).

According to such a configuration, by setting the evaluation formula E2≧0.2, the power of the second lens group 22 can be secured, and cost increase such as an increase in the number of lenses can be avoided. Also, by setting the evaluation formula E2≤1.35, the amount of light reaching the image sensor can be secured, and an increase in shooting time as a spectroscopic camera can be avoided.

A spectroscopic camera according to one aspect of the disclosure includes an etalon that transmits light of a wavelength corresponding to a gap dimension of a pair of reflective films; a detachable mount lens; an image sensor; and a relay optical system that relays an intermediate image formed by the mount lens to re-form an image at the image sensor and is adjusted to make light incident on the etalon at a desired angle,

the relay optical system includes a first lens group that relays the intermediate image to emit a collimated light and make it incident on the etalon, and a second lens group that forms an image of light emitted from the etalon at the image sensor,

a maximum value of an incident angle of the light from the first lens group to the etalon is 15 degrees.

According to such a configuration, by forming an intermediate image with the mount lens and then relaying this intermediate image with the relay optical system to re-form an image at the image sensor, any lens may be selected and configured as the mount lens. In the relay optical system, by setting the incident angle to the etalon to a maximum of 15 degrees, the angle may be set to an appropriate angle that can avoid double peaks in the spectral spectrum that are difficult to correct, and desired spectral characteristics can be obtained.

In the spectroscopic camera according to the aspect, the first lens group has at least one concave lens that emits a collimated light to the etalon, and the convex lens is disposed on the incident side of the concave lens.

According to such a configuration, by passing light from the convex lens on the incident side through at least one concave lens, appropriate collimated light may be emitted to the etalon.

In the spectroscopic camera according to the aspect, the etalon is disposed at a position of an aperture of the relay optical system.

According to such a configuration, by disposing the etalon at the position of the aperture of the relay optical system, appropriate spectral performance can be obtained.

What is claimed is:

1. A spectroscopic camera, comprising:
an etalon that transmits light of a wavelength corresponding to a gap dimension of a pair of reflective films; a detachable mount lens; an image sensor; and a relay optical system that relays an intermediate image formed by the mount lens to re-form an image at the image sensor and is adjusted to make light incident on the etalon at a desired angle,
wherein the relay optical system comprises a first lens group that relays the intermediate image to emit a collimated light and make it incident on the etalon, and a second lens group that forms an image of light emitted from the etalon at the image sensor, and
an image height L1 of the intermediate image and a focal length f1 of the first lens group satisfy E1≤0.27 in an evaluation formula E1 = (L1/f1).

2. The spectroscopic camera according to claim 1, wherein in the relay optical system, the image height L1 of the intermediate image and an image height L2 of an image formed at the image sensor by the second lens group satisfies 0.2≤E2≤1.35 in an evaluation formula E2 = (L2/L1).

3. The spectroscopic camera according to claim 1, wherein the first lens group has at least one concave lens that emits the collimated light to the etalon, and a convex lens is disposed on an incident side of the concave lens.

4. The spectroscopic camera according to claim 2, wherein the first lens group has at least one concave lens that emits the collimated light to the etalon, and a convex lens is disposed on an incident side of the concave lens.

5. The spectroscopic camera according to claim 1, wherein the etalon is disposed at a position of an aperture of the relay optical system.

6. The spectroscopic camera according to claim 2, wherein the etalon is disposed at a position of an aperture of the relay optical system.

7. A spectroscopic camera, comprising:
an etalon that transmits light of a wavelength corresponding to a gap dimension of a pair of reflective films; a detachable mount lens; an image sensor; and a relay optical system that relays an intermediate image formed by the mount lens to re-form an image at the image sensor and is adjusted to make light incident on the etalon at a desired angle,
wherein the relay optical system comprises a first lens group that relays the intermediate image to emit a collimated light and make it incident on the etalon, and a second lens group that forms an image of light emitted from the etalon at the image sensor, and
a maximum value of an incident angle of the light from the first lens group to the etalon is 15 degrees.

8. The spectroscopic camera according to claim 7, wherein the first lens group has at least one concave lens that emits the collimated light to the etalon, and a convex lens is disposed on an incident side of the concave lens.

9. The spectroscopic camera according to claim 7, wherein the etalon is disposed at a position of an aperture of the relay optical system.
